(19) United States
(12) Patent Application Publication
(10) Pub. No.: US 2016/0238104 A1
(43) Pub. Date: Aug. 18, 2016

(54) LOW MASS CHAIN LINK AND ASSEMBLY FOR FRICTION REDUCTION

(71) Applicant: BORGWARNER INC., Auburn Hills, MI (US)

(72) Inventors: Shawn R. VROMAN, Cayuta, NY (US); Timothy J. MAXSON, Ithaca, NY (US)

(21) Appl. No.: 15/026,852

(22) PCT Filed: Oct. 7, 2014
(86) PCT No.: PCT/US2014/059397

§ 371 Date: Apr. 1, 2016

Related U.S. Application Data
(60) Provisional application No. 61/889,182, filed on Oct. 10, 2013.

(51) Int. Cl. F16G 13/06

(52) U.S. Cl. CPC F16G 13/06

(57) ABSTRACT

Roller chain links, both internal and external which include a link outer profile that contains at least one convex back edge. In an alternate embodiment, the link also contains a concave back edge. Additionally, the links may contain an extra hole or window within the link profile combined with the convex and concave edge profiles for additional mass reduction.

### BACKGROUND OF THE INVENTION

1. Field of the Invention

The invention pertains to the field of chain links More particularly, the invention pertains to low mass chain links assembled into a chain for friction reduction.

2. Description of Related Art

In a typical engine timing drive, which may include the primary drive, secondary cam drive, and oil pump drive, a chain can be used to transmit power from one sprocket and shaft to another and allow synchronized rotation between the shafts.

FIG. 1A shows a typical engine timing drive layout consisting of a chain 1, crankshaft sprocket 2, camshaft sprocket 3, tensioner arm 4, tensioning device 5, and guide 6. Power from the crankshaft sprocket 2 is transmitted to the camshaft sprocket 3 through a flexible chain 1, which allows synchronous rotation between the crankshaft 2a and camshaft 3a, which is essential to maintaining engine timing.

As a torque is applied to crankshaft sprocket 2, a resistant torque is applied to camshaft sprocket 3, which then forces the chain 1 to generate a tight strand 7 and a slack strand 8. Typically the chain 1 is in sliding contact between a fixed guide 6 along a portion of chain 1 in tension between the camshaft sprocket 3 and the crankshaft sprocket 2. The chain 1 is also in sliding contact with a movable tensioning arm 4 along the portion of chain 1 between the crankshaft sprocket 2 and the camshaft sprocket 3. The tensioning arm 4 takes up the slack in the chain 1 by pushing into the chain with a force generated by a tensioning device 5.

A typical roller chain 1, as depicted in FIG. 2, consists of a first set of opposed internal link plates 13 connected by a pair of bushings 11, and a second set of opposed internal link plates 14 connected by a pair of pins 10. The link plates 13 of the first set are arranged in an alternating relationship with the link plates 14 of the second set, with each pin 10 from the second set of links 14 extending through the bushing 11 of the first set of links 13. A roller chain 1 will also include a roller 12 located outside the bushing 11, while a rollerless chain would not.

The shapes of the sets of link plates 13, 14 may vary. The shapes of the link plates 13, 14 may be flat back links 15 with a flat back edge 15a as depicted in FIG. 3 or hourglass shaped links 16 with a back edge 16a as depicted in FIG. 4.

The flat back edge 15a of the link is the contact point or surface between the link and the tensioner arm 4 or guide 5. The contact point 15b, where the contact occurs between the links of the chain and the tensioner arm 4 or guide 5, is located across the entire back of the link.

The back edge 16a of the hourglass shaped links 16 is formed of two convexly curved portions 16b connected through a concave portion 16c. The two convexly curved portions 16b are the contact points 16b between the hour glass shaped links 16 and the tensioner arm 4 or guide 5. The curved portions 16b (contact points) are located close to the apertures 17 or joint of the link.

The contact points of theback edges 15a, 16a of the links 15, 16 of the chain 1 come into contact with the sliding surfaces 6a, 4a of the guide 6 and tensioning arm 4 respectively. The flat back links and hourglass shaped links 16 create a large contact area between the flat back edge 15a and the back edge 16a of the chain links 15, 16 and the sliding surfaces 4a, 6a of the tensioner arm 4 and guide 6, creating frictional loss as depicted in FIGS. 1B and 1C. This frictional loss results in lower fuel efficiency when used as an engine timing drive or auxiliary drive within an automotive engine.

Another factor influencing fuel efficiency of an automotive engine concerns the mass of the system being used. A reduction in the mass of the components used results in lower weight of the chain drive, and thus reduces fuel consumption. Specifically in regards to chain drives, lower chain mass can result in lower chain tension, which reduces the force acting upon the sliding surfaces and thus reducing frictional losses.

### SUMMARY OF THE INVENTION

A roller chain or rollerless chain which comprises two distinctly different link sets, internal and external links, which could employ the low mass links and associated geometry on both link sets or just one single link set within the chain. A chain assembly may utilize this link geometry in an alternating fashion so as to allow contact with sliding surfaces on both sides of the chain or to allow contact with sliding surfaces on only one side of the chain while optimizing for friction.

The back edges of the external and internal links which contact the sliding surface of arms and guides within an engine timing drive, oil pump drive, or any other auxiliary drive are optimized for friction reduction. In an embodiment of the present invention, the body of the links have a convex back edge which is formed at least in part by an arc with a radius, such that the radius forms at least one high point of the arc which is centered around the middle of the link, between the apertures or holes of the links for contacting the sliding surfaces of the tensioner arms and/or guides. The radius is preferably optimized for friction reduction and forms the high point of the back edge such that the size of the radius meets pressure/velocity requirements of an application in which the chain is being applied.

In some embodiments, a non-contacting surface is located, opposite the contact surface, and may have a concave shape to eliminate mass from the body of the link. Reduced mass of the link and thus the chain improves the efficiency of the system, as well as improves manufacturing cost and complexity. Mass reduction of the link can also improve overall system efficiency of the chain drive, which can be accomplished with a concave edge profile or the combination of the concave edge profile with an extra hole or window within the profile boundary of the body of the link.

The primary mass reduction is accomplished by the profile of the concave edge, however mass reduction can be accomplished by other means. Instead of a concave profile which removes material and mass from the edge of the link, the link could contain material removal from within the link boundary in the form of an extra hole or window. A link could also contain both a profile with a concave edge combined with material removed from the inside of the link boundary of the body of the link in the form of an extra hole or window. A link could also contain both edges with a convex edge profile to maintain symmetry, combined with material removal from inside the link for mass reduction.

### BRIEF DESCRIPTION OF THE DRAWING

FIG. 1 A shows a conventional engine timing drive.

FIG. 1B shows sliding contact between the chain and tensioner arm.

FIG. 1C shows sliding contact between the chain and the guide.

FIG. 2 shows a conventional roller chain.

FIG. 3 shows conventional flat back link plates of the roller chain of FIG. 1.

FIG. 4 shows conventional hourglass or dogbone link plates of the roller chain of FIG. 1.

FIG. 5A shows a schematic of an internal link plate of an embodiment of the present invention with a convex edge.

FIG. 5B shows a schematic of an external link plate of an embodiment of the present invention with a convex edge.

FIG. 6A shows a schematic of an internal link plate with a hole for reducing the mass of the link of an alternate embodiment of the present invention.

FIG. 6B shows a schematic of an external link plate with a hole for reducing the mass of the link of an alternate embodiment of the present invention.

FIG. 7A shows a schematic of an internal link plate with a window for reducing the mass of the link of another embodiment of the present invention.

FIG. 7B shows a schematic of an external link plate with a window for reducing the mass of the link of another embodiment of the present invention.

FIG. 8A shows a schematic of an oval shaped internal link with a window for reducing the mass of the link in an alternate embodiment of the present invention.

FIG. 8B shows a schematic of an oval shaped external link with a window for reducing the mass of the link in an alternate embodiment of the present invention.

FIG. 9 shows a schematic of a chain with the links arranged such that the convex edge profiles are orientated in the same direction.

FIG. 10 shows a schematic of a chain with the links arranged such that the convex edge profiles are orientated in opposite directions.

FIG. 11 shows a schematic of a chain with the links arranged such that internal links or external links have convex edge profiles and the other set of links are conventional flat back link plates of FIG. 3.

FIG. 12 shows a schematic of a chain with the links arranged such that internal links or external links have convex edge profiles and the other set of links are conventional hourglass or dog bone link plates of FIG. 4.

FIG. 13 shows a schematic of a chain of links with the convex edge profiles of links engaging a tensioner arm.

FIG. 14 shows an isometric three dimensional view of the chain of FIG. 12.

FIG. 15 shows a schematic of a cross-section of the links of FIGS. 5A and 5B along the radius R.

FIG. 16 shows a schematic of an alternate cross-section of embodiment of the links of FIGS. 5A and 5B along the radius R.

### DETAILED DESCRIPTION OF THE INVENTION

The current invention includes a link plate design that incorporates an optimized edge profile shape and link mass reduction.

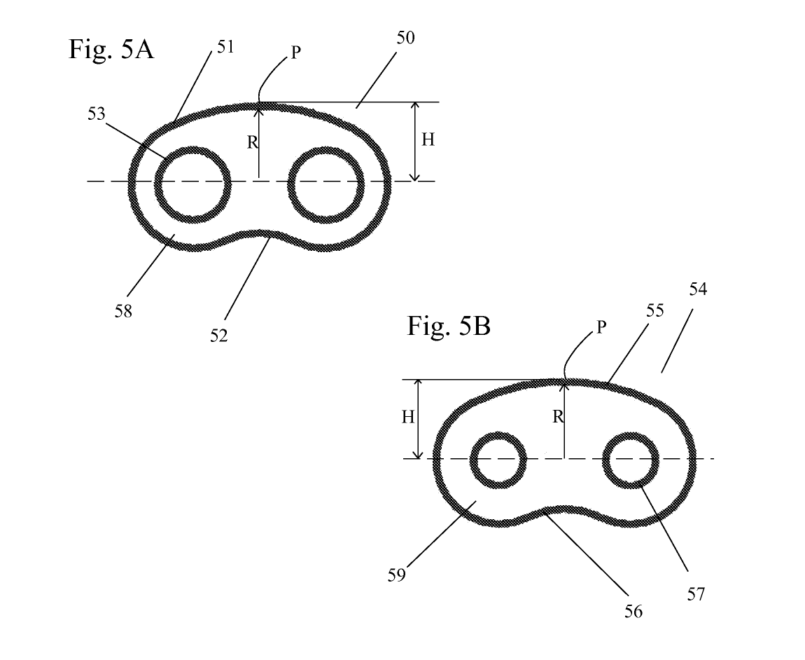

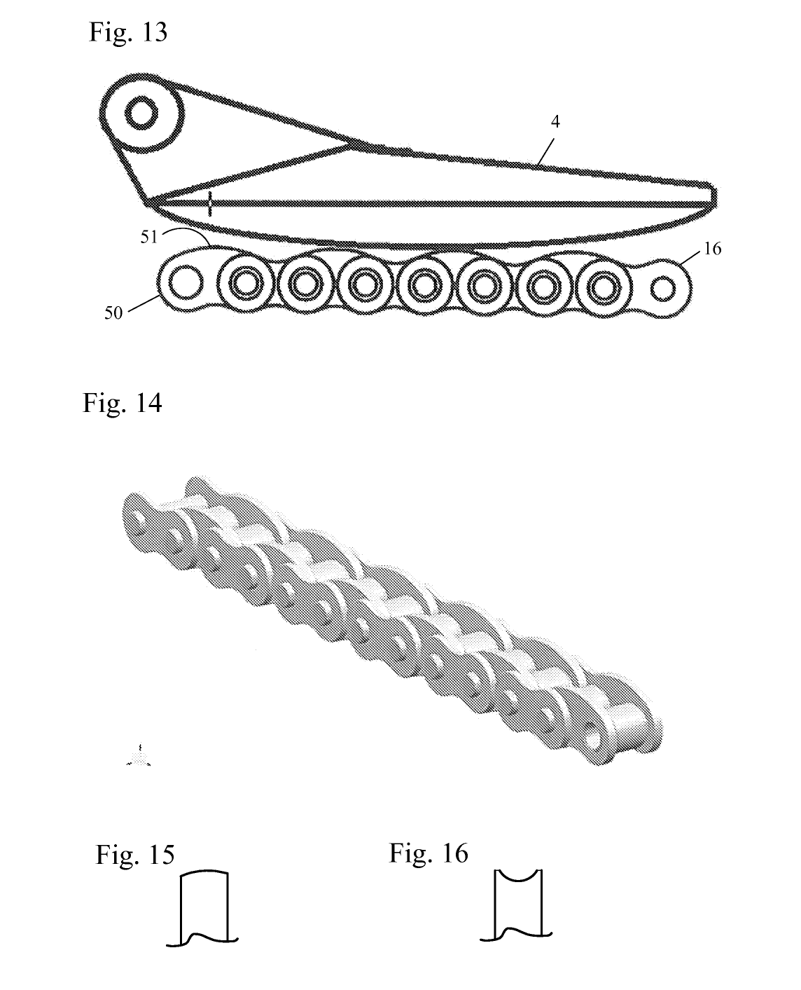

FIG. 5A illustrates an internal link plate 50 with a body 58 which would contain bushings 11 pressed into the link plate apertures or bushing holes 53. The holes may also contain connecting pins (not shown). The internal link plate 50 has a convex back edge 51 for sliding contact with a guide 6 or a tensioner arm 4 as depicted in FIG. 13. The convex back edge 51 has a profile in which at least a portion contacts the sliding surfaces 4a, 6a of arms 4 and guides 6 within an engine timing drive, oil pump drive, or any other auxiliary drive. The profile of the convex back edge 51 is comprised of an arc with a radius R, such that a high point of the profile, formed by the radius R, contacts the sliding surfaces 4a, 6a of the arms 4 and guides 6. The radius R is preferably optimized for friction reduction. By having a back edge 51 with a convex profile with a high point which contacts the sliding surfaces 4a, 6a of the tensioner arm and guide, frictional losses from the sliding contact of the convex shape with the tensioner arm 4 or the guide 6 are reduced.

In embodiments of the present invention, the high point(s) formed by a radius R is moved from around the joint location as shown in the prior art, to the middle of the link and the increase in the size of the radius R meets pressure/velocity requirements of an application as necessary.

The specific radius R which forms the highest point of the profile of the convex back edge is dependent on a number of system parameters such as link thickness, chain tension, plastic pressure/velocity limitations, speed of the drive, temperature of the environment, etc. If the radius is too large the friction reduction will be negligible, and if it is too small the system will reach the pressure/velocity limitations and fail. The highest point(s) formed by the radius R of the arc of the profile of the convex back edge 51 is indicated by P and is the contact point between the link and the sliding surfaces 4a, 6a of the arm 4 and guide 6.

In an exemplary embodiment, the body of the link plate 50 also has a concave edge 52. The concave edge 52 is preferably opposite the convex back edge 51. The concave edge 52 is a non-contacting surface. The profile of the concave edge 52 allows some of the body of the link to be removed, and reduce the mass of the link, for example in comparison to the prior art link of FIG. 3.

FIG. 5B illustrates an external link plate 54 with a body 59 which would contain pins 10 pressed into the link plate pin holes or apertures 57. The external link plate 54 has a convex back edge 55 with a profile for slidingly contacting a guide 6 or a tensioner arm 4 as depicted in FIG. 13. The convex back edge 55 has a profile which contacts the sliding surfaces 4a, 6a of arms 4 and guides 6 within an engine timing drive, oil pump drive, or any other auxiliary drive. The profile of the convex back edge 55 is comprised of an arc with a radius R, such that a high point of the profile, formed by the radius R, contacts the sliding surfaces 4a, 6a of the arms 4 and guides 6. The radius R is preferably optimized for friction reduction. By having a back edge 55 with a convex profile with a high point which contacts the sliding surfaces 4a, 6a of the tensioner arm and guide, frictional losses from the sliding contact of the convex shape with the tensioner arm 4 or the guide 6 are reduced. The highest point(s) formed by the radius R of the arc of the profile of the convex back edge 55 is indicated by P and is the contact point between the link and the sliding surfaces 4a, 6a of the arm 4 and guide 6.

Mass reduction of the link can also take the form of additional holes or windows within the profile of the body of the link by removing material from within the boundary of the link profile in areas in which the material is not needed, for example between the link plate bushing holes 53 or the link plate pin holes 57.

The amount of material removed for mass reduction is taken into consideration with the functional requirements of link strength and stiffness, since the links are the load carrying component of the chain assembly. The extra hole or window must also not contain a shape that could jeopardize the integrity of the link by adding stress concentrations within the link.

The contact surfaces P of the back edges 51, 55 of the links that are in sliding contact with a tensioner 4 or a guide 6 are historically flat when viewed as a cross section through the link thickness. However, the contour of the link edge when viewed through the cross section of the link thickness may be optimized for friction reduction as well. This could include a convex shape which would look like a rounding off of the link edge, for example as shown in FIG. 15 or a concave radius which would look similar to an ice skate blade, for example as shown in FIG. 16. The shape may also be optimized to take advantage of the pressure/velocity properties of the materials used as the sliding surfaces of the tensioner arms 4 and guides 6.

The links of the present invention may also have a shape along the profile of the link in which the convex back edge and concave edge are asymmetrical about an imaginary line perpendicular to a line (dashed line) passing through the centers of the bushing holes 53 or the pin holes 57.

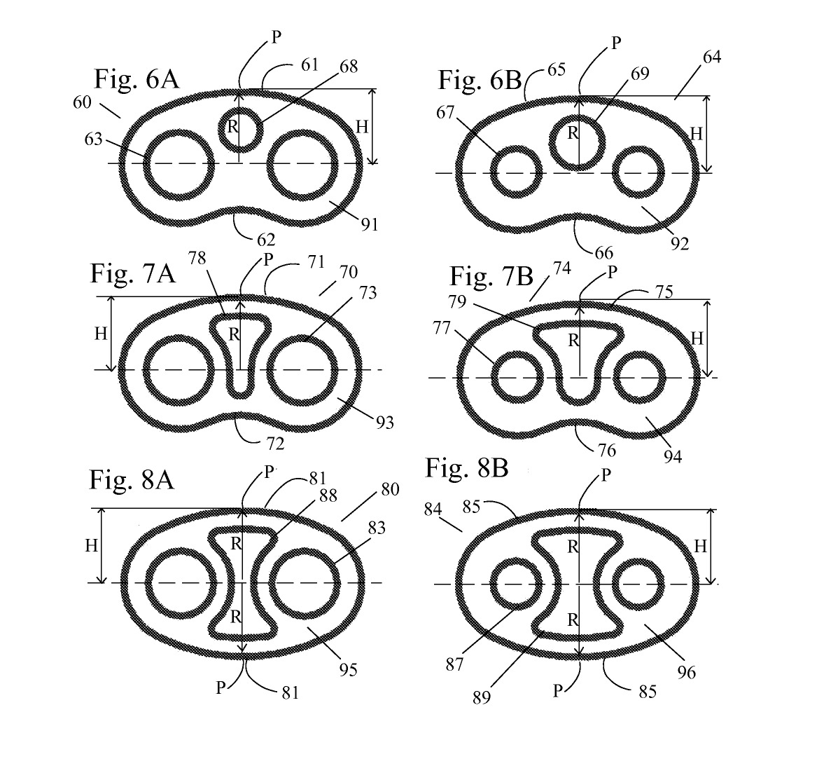

FIGS. 6A and 7A show examples of internal links 60, 70 which have a body 91, 93 that defines apertures or link plate bushing holes 63, 73 that would receive bushings 11. The body 91, 93 of the internal links 60, 70 each contain a convex back edge 61, 71 having a profile for sliding contact with a tensioner arm 4 or a guide 6 and a concave edge 62, 72, opposite at least a portion of the the convex back edge 61, 71. The body of the internal links also contain a hole 68 or window 78 to reduce the mass of the links 60, 70. The hole 68 or window 78 is preferably located between the link plate bushing holes 63, 73. The hole 68 is preferably circular in shape. The window 78 is preferably generally triangular or bell-shaped.

The profile of the convex back edge 61, 71 is comprised of an arc with a radius R, such that a high point of the profile, formed by the radius R, contacts the sliding surfaces 4a, 6a of the arms 4 and guides 6. The radius R is preferably optimized for friction reduction. The highest point(s) formed by the radius R of the arc of the profile of the convex back edge 61, 71 is indicated by P and is the contact point between the link and the sliding surfaces 4a, 6a of the arm 4 and guide 6.

FIGS. 6B and 7B shows examples of external links 64, 74 that may be paired with internal links 60, 70 of FIGS. 6A and 7A. The external link plates 64, 74 each have a body 92, 94 that defines apertures or link plate pin holes 67, 77 for receiving pressed pins 10. The body 92, 94 of the external link plates 64, 74 each contain a convex back edge 65, 75 with a profile for sliding contact with a tensioner arm 4 or a guide 6 and a concave edge 66, 76 opposite at least a portion of the convex back edge 65, 75. The concave edge 66, 76 reduces the mass of the link in addition to a hole 69 or window 79 between the link plate pin holes 67, 77. The hole 69 is preferably circular in shape. The window 79 is preferably generally triangular or bell-shaped.

The profile of the convex back edge 65, 75 is comprised of an arc with a radius R, such that a high point of the profile, formed by the radius R, contacts the sliding surfaces 4a, 6a of the arms 4 and guides 6. The radius R is preferably optimized for friction reduction. The highest point(s) formed by the radius R of the arc of the profile of the convex back edge 65, 75 is indicated by P and is the contact point between the link and the sliding surfaces 4a, 6a of the arm 4 and guide 6.

In some instances, a chain of an engine chain drive does in fact need to contact sliding surfaces 4a, 6a of tensioner arm 4 and guide 6 along both the outer and inner periphery of the chain. In those particular cases, the internal links 80 and external links 84, for example as shown in FIGS. 8A-8B may be utilized. The internal links 80 and external links 84 have a body 95, 96 with an outer circumference which is oval shaped, with convex back edges 81, 85 on opposite sides of the link. A hole or window 88, 89 is present between the link plate bushing holes 83 or link plate pin holes 87 for reducing the mass of the link. The hole or window 88, 89 is preferably hour-glass in shape.

The profile of the convex back edges 81, 85 is comprised of an arc with a radius R, such that a high point of the profile, formed by the radius R, contacts the sliding surfaces 4a, 6a of the arms 4 and guides 6. The radius R is preferably optimized for friction reduction. The highest point(s) formed by the radius R of the arc of the profile of the convex back edge 81, 85 is indicated by P and is the contact point between the link and the sliding surfaces 4a, 6a of the arm 4 and guide 6.

It should be noted that the placement of the holes 68, 69 or windows 78, 79, 88, 89 are such that the strength and integrity of the links are not compromised.

In regards to the chain assembly, the two link types (internal and external) could be arranged in a few different arrangements depending on requirements of the chain assembly.

1. One of the two links may use a link with a convex back edge.

2. Both internal and external links have a convex back edge oriented in the same direction.

3. Both internal and external links have a convex back edge and are oriented in an alternating or opposite direction. In other words, one link set would have all links with the convex edge in one direction while the other link set contains the convex edge in the opposite direction.

Depending on the application and how the chain is used, any combination of link shapes as defined within this invention record can be arranged and used to satisfy the requirements of the chain drive.

The internal links 50, 60, 70, 80 and external links 54, 64, 74, 84 of FIGS. 5A, 5B, 6A, 6B, 7A, 7B, 8A, 8B may be arranged a number of ways within the chain assembly in an optimized fashion. The link profile shapes as defined with this invention could also be combined with a traditional flat back link 15 (FIG. 3) or hourglass/dog bone shaped links 16 (FIG. 4) to further optimize friction loss and mass reduction.

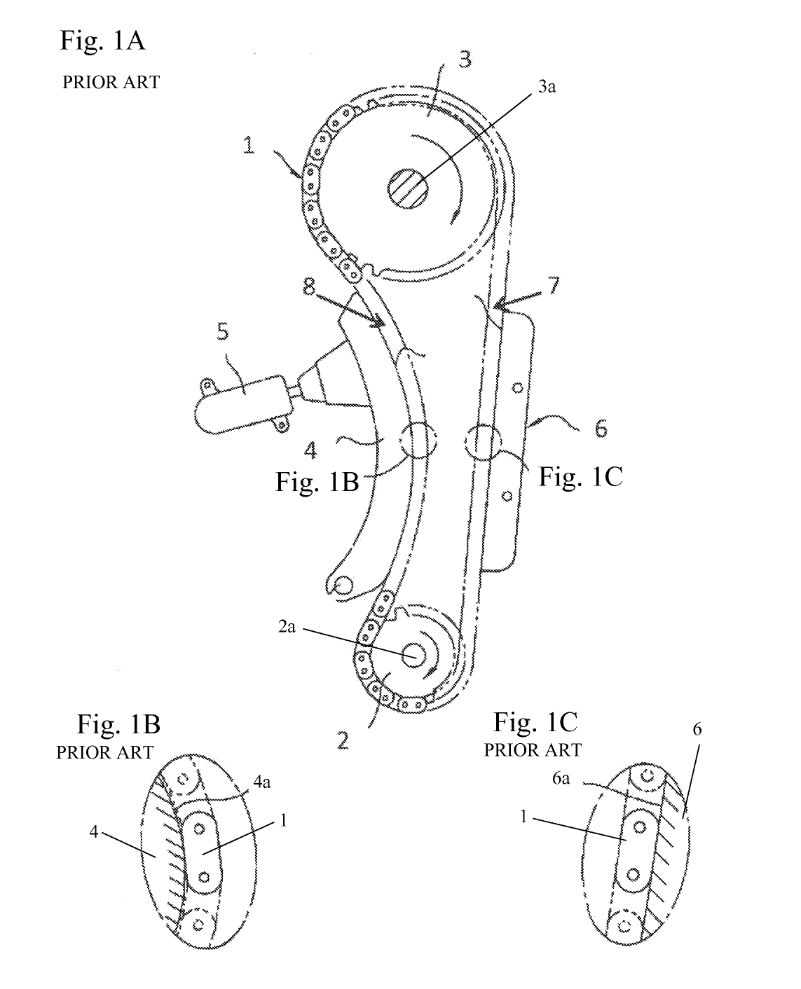

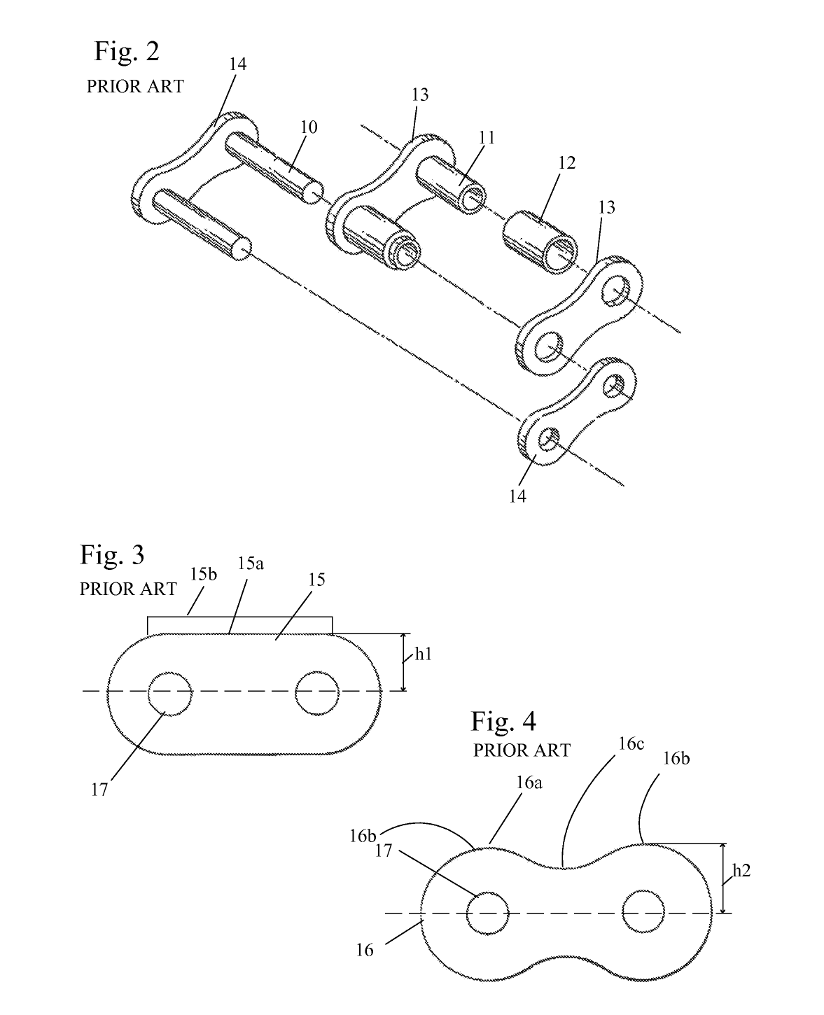

For example, as depicted in FIG. 9, a chain assembly could contain a link plate set of an internal link 50 as depicted in FIG. 5A and an external link 54 as depicted in FIG. 5B in an alternating relationship. The convex edge 51 of the internal link 50 and the convex edge 55 of the external link 54 may be positioned in the same orientation, with the highest points P of the profiles of the convex back edges aligned. This chain assembly could be utilized in a chain drive application where the chain 1 will contact sliding surfaces along one side of the chain design, either the inner or the outer periphery of the chain, but not both. A typical application of this design is depicted in FIG. 1A, whereby the chain 1 contacts sliding surfaces 4a, 6a of tensioner arm 4 and guide 6 along the outer periphery of the chain 1. The internal links 51 and external links 54 would be oriented with the highest point P of the convex edges 51, 55 making contact with the sliding surfaces 4a, 6a. It should be noted that the orientation of the links could also be made using the internal and external links of FIGS. 6A and 6B and the internal and external links of FIGS. 7A and 7B.

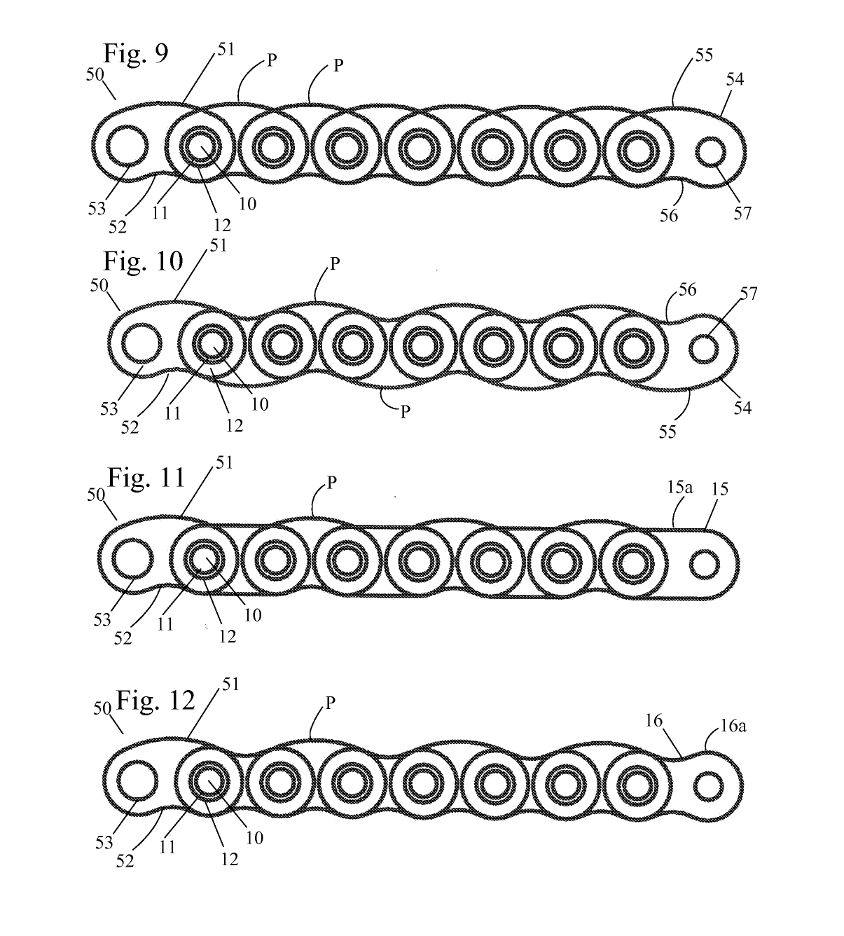

In another example, a chain assembly could contain an internal link 50 as depicted in FIG. 5A and an external link 54 as depicted in FIG. 5B in an alternating relationship, as shown in FIG. 10, where the highest point P of the convex back edge 51 of the internal link 50 is oriented in one direction and the highest point P of the convex back edge 55 of the external link 54 is oriented in the opposite direction of convex edge 51 of the internal link 50. This chain assembly could be utilized in a chain drive application where the chain 1 will contact sliding surfaces along both the inner and outer periphery of the chain assembly within the application. It should be noted that the orientation of the links could also be made using the internal links 60 and external links 64 of FIGS. 6A and 6B, the internal links 70 and external links 74 of FIGS. 7A and 7B, and internal links 80 and external links 84 of FIGS. 8A and 8B.

In yet another example, as shown in FIG. 11, a chain assembly could contain internal links 50 as depicted in FIG. 5A or external links 54 as depicted in FIG. 5B combined with a traditional flat back link 15 as shown in FIG. 3 in an alternating relationship. The internal links 50 or external links 54 with the convex edge 51, 55 contacts the sliding surfaces 6a, 4a of the guide 6 or tensioner 4 only, while the traditional flat back link 15 does not. In this case, the traditional flat back link 15 is shorter in height h1 when measured from an imaginary line perpendicular to a line drawn from the center of one pin or bushing hole to the center of the other pin or bushing hole, than the height H of the links containing the convex edge 51, 55. This similarly is true for the internal links 60 and external links 64 of FIGS. 6A and 6B, the internal links 70 and external links 74 of FIGS. 7A and 7B, and internal links 80 and external links 84 of FIGS. 8A and 8B.

Since the flat back link 15 is shorter in height h1, the flat back edge 15a does not make contact the sliding surfaces 4a, 6a of the tensioner arm 4 or guide 6. It should be noted that the orientation of the links could also be made using the internal links 60 and external links 64 of FIGS. 6A and 6B and the internal links 70 and external links 74 of FIGS. 7A and 7B.

It should be noted that while the height of the links in FIGS. 5A-8A are indicated as “H”, the actual height measured from an imaginary line perpendicular to a line drawn from the center of one pin or bushing hole to the center of the other pin or bushing hole may vary between the links, however the height is always greater than the height h1, h2 of the flat back link and the hourglass-shaped link of FIGS. 3 and 4.

In another example, as shown in FIG. 12 a chain assembly could contain an internal links 50 as depicted in FIG. 5A or external links 54 as depicted in FIG. 5B combined with a traditional hourglass shaped links 16 as shown in FIG. 4 arranged in an alternating relationship. FIG. 14 is a three dimensional isometric view illustrating the chain of FIG. 13.

In this case, the highest points P of the internal links 50 or external links 54 with the convex back edges 51, 55 contacts the sliding surfaces 6a, 4a of the guide 6 or tensioner 4 only, while the traditional hourglass shaped or dog bone shaped link 16 does not. In this case the traditional hourglass shaped link 16 is shorter in height h2 when measured from an imaginary link perpendicular to a line drawn from the center of one pin or bushing hole to the center of the other pin or bushing hole to than the height H of the internal links 50 or external links 54 with the convex back edge 51, 55. Since the hourglass shaped link 16 is shorter in height h2 it does not make contact with the sliding surfaces 4a, 6a of the tensioner arm 4 or guide 6. It should be noted that the orientation of the links could also be made using the internal links 60 and external links 64 of FIGS. 6A and 6B and the internal links 70 and external links 74 of FIGS. 7A and 7B.

Embodiments of the present invention may be used for engine timing applications where a chain is used to transfer power from one sprocket and shaft to another and the chain contacts sliding surfaces on tensioner arms and guides. Possible engine drives which are chain driven include primary drives, secondary drives, oil pump drives, balance shaft drives, fuel pump drives, and any other auxiliary drive within the engine.

Embodiments of the present invention could be applied to any automotive application where a chain is used to transfer power from one sprocket or shaft to another and contacts sliding surfaces for control purposes. This may include automotive transmissions, transfer cases, power transfer units, hybrid drives, transmission oil pump drives, etc.

Embodiments of the present invention may also be used in any application which utilizes a chain for transfer of power and also contacts guiding surfaces.

Embodiments of the present invention are not limited to link size, link pitch, link thickness, or any other dimensional properties related to chain design.

Embodiments of the present invention are not restricted to specific material properties. In most automotive applications, steel links would be used. Other industrial applications which utilize a chain drive could employ other materials such as plastics, ceramics, etc.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A link for a chain in contact with a tensioner or guide comprising:
a pair of apertures for receiving at least connecting pins;
at least one contact surface, comprising an arc with a radius, the radius defining at least one point of contact on the arc on the contact surface between the contact surface and the tensioner or guide, the point of contact being located between the pair of apertures; and
a window between the pair of apertures.

2. The chain link of claim 1, wherein the link further comprises a non-contact surface in the form of a concave arc, opposite the contact surface.

3. The chain link of claim 1, wherein the window is circular.

4. The chain link of claim 1, wherein the window is hourglass-shaped.

5. The chain link of claim 1, wherein the window is generally triangular in shape.

6. The chain link of claim 1, wherein the link comprises two contact surfaces on opposite sides of a line drawn through the pair of apertures.

7. A chain comprising:
a plurality of links coupled together by connecting elements received by a pair of apertures, wherein at least some of the links comprise:
at least one contact surface, comprising an arc with a radius, the radius defining at least one point of contact on the arc on the contact surface between the contact surface and the tensioner or guide, the point of contact being located between the pair of apertures; and
a window between the pair of apertures.

8. The chain of claim 7, wherein the window is circular.

9. The chain of claim 7, wherein the window is hourglass-shaped.

10. The chain of claim 7, wherein the window is generally triangular in shape.

11. The chain of claim 7, wherein the plurality of links are arranged such that the at least one point of contact of all the links are adjacent.

12. The chain of claim 7, wherein the plurality of links are arranged such that the at least one point of contact of the links are on opposite sides of a line drawn through the pair of apertures.

13. The chain of claim 7, wherein at least some of the links have flat back edges.

14. The chain of claim 7, wherein at least some of the links are hourglass-shaped links.
